(19) United States
(12) Patent Application Publication
(10) Pub. No.: US 2014/0245243 A1
(43) Pub. Date: Aug. 28, 2014

(54) COMPUTING DEVICE AND METHOD FOR GENERATING COMPONENT MODULE FILES OF CIRCUIT DIAGRAM

(71) Applicants: Hon Hai Precision Industry Co., Ltd., New Taipei (TW); Hong Fu Jin Precision Industry (ShenZhen) Co., Ltd., Shenzhen (CN)

(72) Inventor: JIAN-SHE SHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/965,236

(22) Filed: Aug. 13, 2013

(30) Foreign Application Priority Data
Feb. 27, 2013 (CN) 2013100619905

(51) Int. Cl. G06F 17/50

(52) U.S. Cl. CPC G06F 17/505
USPC 716/105

(57) ABSTRACT

A circuit diagram includes a plurality of components. Each component corresponds to a module number and a component number. The components corresponding to a same module number are classified into a same function module. Each function module corresponds to a component module file. The component module file of each function module is generated according to the classified function modules. The component module file includes the module number of the function module and the component numbers of the components which are included in the function module. The component module files of the circuit diagram can be imported in a printed circuit board (PCB) drawing software.

### BACKGROUND

1. Technical Field

Embodiments of the present disclosure relate to circuit wiring technology, and particularly, to a computing device and a method for generating component module files of a circuit diagram.

2. Description of Related Art

A circuit diagram of a product includes a plurality of components. In a wiring process, a wiring engineer manually lays components of the circuit diagram according to schematic positions of the components in the circuit diagram and other related components. However, the manual operation may result in mistakes, and it is difficult to check whether the components are placed in right places of the diagram.

### BRIEF DESCRIPTION OF THE DRAWINGS

FIG. 1 is a block diagram of one embodiment of a computing device comprising a generation system.

FIG. 2 is a block diagram of one embodiment of function modules of the file generation system in the computing device of FIG. 1.

FIG. 3 illustrates a flowchart of one embodiment of a method of generating component module files of a circuit diagram in the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

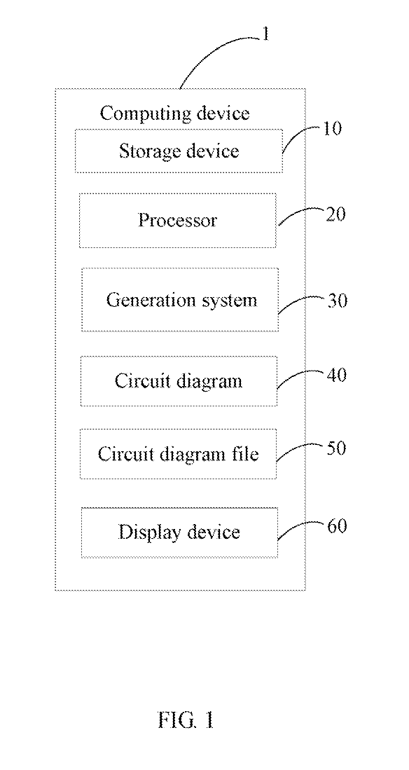

FIG. 1 is a block diagram of one embodiment of a computing device 1. The computing device 1 includes a storage device 10, a processor 20, a generation system 30 (hereinafter “the system 30”), a circuit diagram 40, and a circuit diagram file 50. The computing device 10 may further include a display device 60, or the computing device 10 may be electronically connected to a display device 60.

In one embodiment, the storage device 10 may include some type(s) of computer-readable non-transitory storage medium, such as a hard disk drive, a compact disc, a digital video disc, or a tape drive.

The circuit diagram 40 is divided into one or more function modules according to functions of the circuit diagram 40. For example, the circuit diagram 40 may be divided into a baseboard management controller (BMC) function module, a graphics processing unit (GPU) function module, and a central processing unit (CPU) function module. Each function module corresponds to a component module file, and has a module number which is used to identify the function module. Each function module includes one or more components. Each component of the function module has a component number which is used to identify the component, and is associated with the module number of the function module. The circuit diagram file 50 includes all the component numbers of the components in relation to the circuit diagram 40 and the module numbers associated with the components. In one embodiment, if the circuit diagram 40 is drawn using drawing software, the circuit diagram file 50 can be exported from the drawing software and be stored in a specified folder, which is stored in the storage device 10 of the computing device 1.

The system 30 generates the component module files of the function modules according to the circuit diagram file 50. Furthermore, the system 30 classifies one or more components which are associated with the same module number into a function module. For example, the circuit diagram 40 includes more components, such as A1, A2, B1, and B2, where the module number associated with A1 is 241, the module number associated with A2 is 241, the module number associated with B1 is 242, the module number associated with B2 is 242, therefore, A1 and A2 are classified into one function module, B1 and B2 are classified into another function module. Each function module corresponds to a component module file. The component module file includes the module number of the function module and the component numbers of all the components which are included in the function module. In one embodiment, the component module files of the circuit diagram 40 can be imported into a printed circuit board (PCB) drawing software. The PCB drawing software can automatically complete all of the wiring according to the component module files.

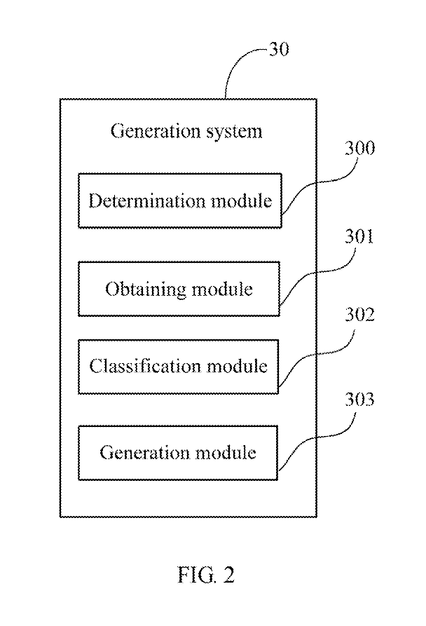

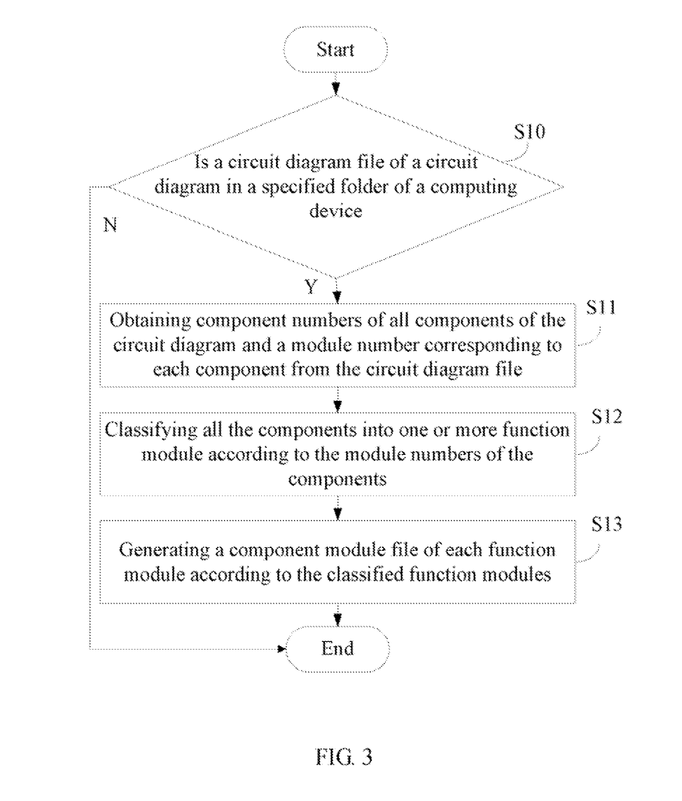

FIG. 2 is a block diagram of one embodiment of function modules of the system 30. In one embodiment, the system 30 may include a determination module 300, an obtaining module 301, a classification module 302, and a generation module 303. The function modules 300-303 may include computerized codes in the form of one or more programs, which are stored in the storage device 10. The processor 20 executes the computerized codes, to provide functions of the function modules 300-303. A detailed description of the function modules 300-303 is given in reference to FIG. 3.

FIG. 3 illustrates a flowchart of one embodiment of a method of generating component module files of the circuit diagram 40 in the computing device 1 of FIG. 1. Depending on the embodiment, additional steps may be added, others removed, and the ordering of the steps may be changed.

In step S10, the determination module 300 determines whether the circuit diagram file 50 of the circuit diagram 40 is in a specified folder of the computing device 1. If the circuit diagram file 50 is in the specified folder of the computing device 1, step S11 is implemented. If the circuit diagram file 50 is not in the specified folder of the computing device 1, the procedure ends.

In step S11, the obtaining module 301 obtains component numbers of all components of the circuit diagram 40 and a module number corresponding to each component from the circuit diagram file 50. In one embodiment, the circuit diagram 40 is divided into one or more function modules according to functions of the circuit diagram 40. As mentioned above, the circuit diagram 40 may be divided into a BMC function module, a GPU function module and a CPU function module. Each function module corresponds to a component module file, and a module number. The module number is used to identify the function module.

In step S12, the classification module 302 classifies components which correspond to a same module number into a same function module.

In step S13, the generation module 303 generates a component module file of each function module according to the classified function modules.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

1. A computerized method being executed by at least one processor of a computing device, the method comprising:
obtaining component numbers of components of a circuit diagram from a circuit diagram file stored in a storage device of the computing device, and obtaining a module number corresponding to each component from the circuit diagram file;
classifying the components into one or more function modules of the circuit diagram according to the module numbers of the components using the at least one processor, the components corresponding to a same module number being classified into a same function module, each function module corresponding to a function of the circuit diagram; and
generating a component module file for each function module according to the classified function modules, wherein the component module file comprises the module number of the function module and the component numbers of the components which are included in the function module.

2. (canceled)

3. The method according to claim 1, wherein each component corresponds to one function module.

4. A computing device, comprising:
a processor; and
a storage device that stores one or more programs, when executed by the at least one processor, cause the at least one processor to perform a component module files generation method, the method comprising:
obtaining component numbers of components of a circuit diagram from a circuit diagram file stored in a storage device, and obtaining a module number corresponding to each component from the circuit diagram file;
classifying the components into one or more function modules of the circuit diagram according to the module numbers of the components, using the processor, the components corresponding to a same module number being classified into a same function module, each function module corresponding to a function of the circuit diagram; and
generating a component module file for each function module according to the classified function modules, wherein the component module file comprises the module number of the function module and the component numbers of the components which are included in the function module.

5. (canceled)

6. The computing device according to claim 4, wherein each component corresponds to a only one function module.

7. A non-transitory storage medium having stored thereon instructions that, when executed by a processor of a computing device, causes the processor to perform component module file generation method in the computing device, wherein the method comprises:
obtaining component numbers of components of a circuit diagram from a circuit diagram file stored in a storage device, and obtaining a module number corresponding to each component from the circuit diagram file;
classifying the components into one or more function modules of the circuit diagram according to the module numbers of the components, using the processor, the components corresponding to a same module number being classified into a same function module, each function module corresponding to a function of the circuit diagram; and
generating a component module file for each function module according to the classified function modules, wherein the component module file comprises the module number of the function module and the component numbers of the components which are included in the function module.

8. (canceled)

9. The non-transitory storage medium according to claim 7, wherein each component corresponds to a only one function module.
